(19) United States
(12) Patent Application Publication
(10) Pub. No.: US 2025/0219228 A1
(43) Pub. Date: Jul. 3, 2025

(54) ENERGY STORE FOR A MOTOR VEHICLE

(71) Applicant: MAN Truck & Bus SE, München (DE)

(72) Inventors: Martin HÄUPLER, München (DE); Martin UMBREIT, München (DE); Björn ALDIEK, Heilbronn (DE); Michael BERNATH, MÜNCHEN (DE); Adrian FINK, München (DE); Mark ZIMMERMANN, München (DE)

(21) Appl. No.: 18/853,103

(22) PCT Filed: Mar. 23, 2023
(86) PCT No.: PCT/EP2023/057431

§ 371 Date: Sep. 30, 2024

(30) Foreign Application Priority Data
Mar. 30, 2022 (DE) 10 2022 107 618.0

(51) Int. Cl. H01M 50/262; B60L 50/60; B60L 50/64; H01M 10/613; H01M 10/615; H01M 10/625; H01M 10/6554; H01M 50/204; H01M 50/249; H01M 50/258

(52) U.S. Cl. CPC H01M 50/262; B60L 50/64; B60L 50/66; H01M 10/613; H01M 10/615; H01M 10/625; H01M 10/6554; H01M 50/204; H01M 50/249; H01M 50/258; B60L 2200/18; H01M 2220/20

(57) ABSTRACT

The present invention relates to an electric energy storage (10) for a motor vehicle. A plurality of battery module groups (14) each comprise a plurality of battery modules (20) each of a plurality of battery cells. A plurality of containers (12) are stacked and each comprise a substantially frame-shaped container outer wall (18), wherein one of the plurality of battery module groups (14) is arranged in each of the plurality of containers (12). A plurality of fastening elements (16), which are elongated, extend through the container outer walls (18) of the plurality of containers (12) and fasten the containers (12) to one another. The elongated fastening elements (16) passing through all the containers (12) are advantageous in that they enable a modular, freely scalable design of the electric energy storage (10) with a free geometric configuration, low weight and costs, as well as simple, quick assembly and disassembly.

The invention relates to an electric energy storage for a motor vehicle and a motor vehicle with an electric energy storage.

Electric energy storages for motor vehicles are sufficiently well known from the prior art. For example, WO 2006/043163 A1 discloses a battery module that forms a unit for constructing a battery assembly, which comprises a cell unit with a plurality of cells, as well as a housing and a cover for accommodating the cell unit. The battery module further comprises a shaft member that is inserted into a through-hole provided in the cell unit and into a through-hole provided in the case and into a through-hole provided in the cover. The shaft element comprises a length that allows it to protrude from both the housing and the cover. In addition, during the construction of the battery module, the shaft element serves as a template for inserting the lid, the cell unit and the housing in the order mentioned for each of the modules within the battery assembly.

The invention is based on the task of creating an improved energy storage for a motor vehicle.

The task is solved by the features of independent claim 1. Advantageous further embodiments are given in the dependent claims and the description.

One aspect of the present disclosure relates to an electric energy storage for a motor vehicle, preferably a utility vehicle (e.g. lorry or bus). The energy storage comprises a plurality (e.g.

two, three or four) of battery module groups, each comprising a plurality of battery modules each comprising a plurality (e.g. braced together) of battery cells (e.g. battery cell stacks). Preferably, the multiple battery modules per battery module group can be arranged in one plane, particularly preferably in a row next to each other or in a grid. The energy storage further comprises a plurality of (e.g. two, three or four) containers which are stacked (e.g. on top of each other) and each comprise a substantially frame-shaped container outer wall, wherein one of the plurality of battery module groups is arranged in each of the plurality of containers. The energy storage further comprises a plurality of fastening elements that are elongate (and e.g. rod-shaped), each extending through the container outer walls of the plurality of containers and fastening the containers to each other (e.g. in a gas-tight manner).

Advantageously, the long fastening elements running through all containers enable a modular, freely scalable design of the electric energy storage with a free geometric design, low weight and costs as well as simple, quick assembly and disassembly. The modular design of the energy storage consisting of any number of containers/battery module groups can enable a wide range of possible uses in various vehicle and customer applications in the commercial vehicle sector (e.g. lorries or buses) or other areas of application. Special tools (e.g. angle screwdrivers) can be avoided. The fastening elements can be easily accessed linearly from above. Compared to alternating screw connections between neighbouring containers, the continuous fastening elements enable a comparatively small number of screw connections, which means that costs and weight can be reduced. The long length of the fastening elements enables a high level of robustness against component tolerances, thermal expansion and other loads during operation. Bolting forces can be applied more evenly to the outer walls of the container and any sealing elements arranged in between due to the long fastener lengths and clamping lengths. This means that the local stress on the components can be reduced, which has the effect of increasing their service life.

Preferably, the plurality of fastening elements can fasten the plurality of containers to each other without the plurality of battery module groups being braced together.

In one embodiment example, the container outer walls are each substantially polygonal frame-shaped or substantially rectangular frame-shaped, and/or the container outer walls are each completely circumferential/encircling.

In a further embodiment example, the plurality of fastening elements are each secured within the electric energy storage (e.g., in one of the containers or in one of the outer walls of the containers). Preferably, the plurality of fastening elements are each screwed into a blind hole or a through-thread in a base (bottom) of the electric energy storage or the container outer wall of an outermost, preferably lowermost, container of the plurality of containers. Advantageously, this allows the fastening elements to be secured in a particularly secure and protected manner.

Alternatively, the plurality of fastening elements may each be secured outside the electric energy storage, wherein preferably the plurality of fastening elements each extend through a through-hole in a base (bottom) of the electric energy storage or the container outer wall of an outermost, preferably lowermost, container of the plurality of containers and/or are each secured with a nut connection.

In a further embodiment example, the container outer walls comprise respective corner wall portions and substantially straight wall portions arranged therebetween, and a plurality of fastening elements extend through each of the substantially straight wall portions.

In a further embodiment example, the multiple fastening elements are configured as screws, bolts or threaded rods.

In a further embodiment example, a number of the plurality of fastening elements is ≥10, ≥15, ≥20, ≥25, ≥30, ≥35 or ≥40. Alternatively or additionally, the plurality of fastening elements are arranged substantially equidistantly, and/or the plurality of fastening elements together form a lattice bar cage that surrounds the battery module groups in a protective manner. Alternatively or additionally, the plurality of fastening elements are arranged in a coordinated manner (e.g. equidistantly or non-equidistantly) to apply a uniform fastening force around a circumference of the frame-shaped container outer walls.

In a further embodiment, the multiple fastening elements connect the container outer walls of the plurality of containers to each other in an electrically conductive manner for potential equalisation.

In a further embodiment example, the electric energy storage further comprises at least one frame-shaped sealing element, which is preferably arranged between opposing end faces of two neighbouring containers of the plurality of containers. Preferably, the multiple fastening elements can each extend through the at least one frame-shaped sealing element (e.g. through through-holes in the sealing element).

For example, the frame-shaped sealing element may comprise a metal seal, an elastomer seal, a plastic seal, a sealing cord and/or a sealing paste or sealing fluid.

In a further embodiment example, the electric energy storage further comprises a plurality of, preferably pin-shaped, centring elements that align the containers with each other, preferably in a flush manner. Preferably, the multiple centring elements can be arranged on the end faces of the container outer walls of the containers.

In a further embodiment example, the multiple containers each comprise at least one, preferably strut-shaped or wall-shaped, stiffening element, which preferably extends between opposite inner sides of the container outer wall of the respective container and/or is arranged between the multiple battery modules of the respective battery module group. Advantageously, additional structural stiffening components (struts, support plate, crash pads) can thus support forces arising in the event of an accident and protect vulnerable components (e.g. battery modules) from damage. The energy storage can thus be designed to be particularly safe, so that even in the event of a fault and during and/or after an accident situation, a safe high-voltage battery system is available and any risk to people and the environment is minimised.

In a further embodiment, the plurality of containers each comprise a vent valve for venting the respective container when a predetermined pressure is exceeded. Preferably, the container outer walls can each comprise a passage in which the vent valve of the respective container is arranged.

In a further embodiment example, the plurality of containers each comprise a, preferably bottom-side, temperature control device, preferably a cooling and/or heating plate, for controlling the temperature of the battery module group arranged in the respective container.

In a further embodiment example, the plurality of containers each comprise a bottom-side support plate which supports the battery module group arranged in the respective container and/or stiffens the respective container.

In a further embodiment example, the plurality of containers each comprise a heat insulating element which is substantially frame-shaped and arranged between the container outer wall of the respective container and the battery module group arranged in the respective container.

In a further embodiment example, the electric energy storage further comprises a, preferably plate-shaped, cover, which covers an uppermost one of the plurality of containers from above, and optionally an upper heat insulating layer, which is arranged between the cover and the uppermost container. Preferably, the electric energy storage can additionally comprise an upper frame-shaped sealing element, which is preferably arranged between the uppermost container and the upper heat insulating layer or the cover.

In a further embodiment example, the electric energy storage further comprises a, preferably plate-shaped, bottom, which covers a lowermost one of the plurality of containers from below, and optionally a lower heat insulating layer arranged between the bottom and the lowermost container. Preferably, the electric energy storage can additionally comprise a lower frame-shaped sealing element, which is preferably arranged between the lowermost container and the lower heat insulating layer or the bottom.

Another aspect of the present disclosure relates to a motor vehicle, preferably a utility vehicle, particularly preferably a lorry or bus, comprising an electric energy storage as disclosed herein. Preferably, the electric energy storage is arranged at, on or between a ladder frame of the motor vehicle or on a roof of the motor vehicle.

The preferred embodiments and features of the invention described above can be combined with one another as desired. Further details and advantages of the invention are described below with reference to the accompanying drawings. It shows:

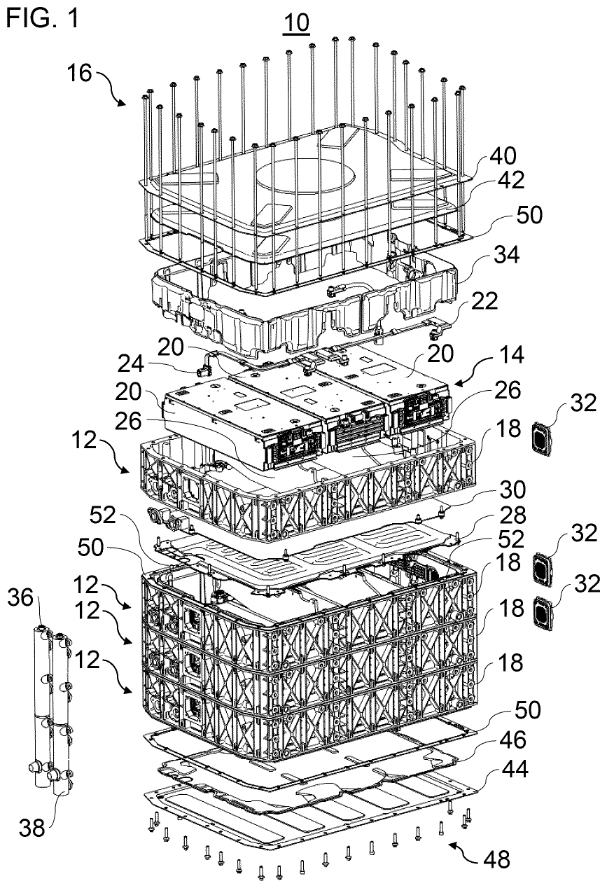

FIG. 1 an exploded view of an energy storage according to an embodiment of the present disclosure; and

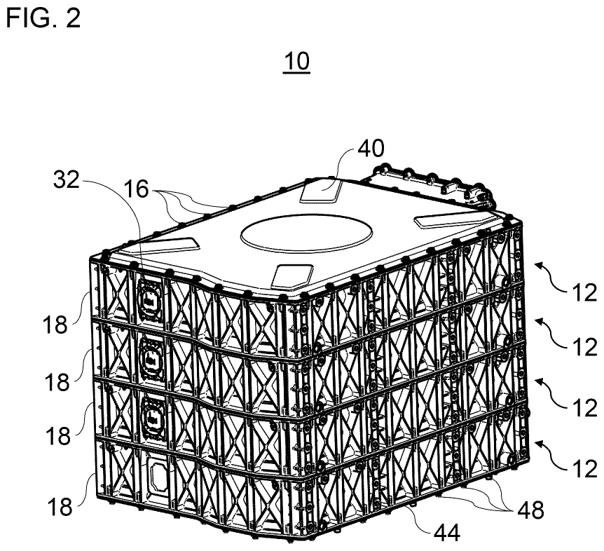

FIG. 2 a perspective view of an energy storage in assembly according to an embodiment of the present disclosure.

The embodiments shown in the figures are at least partially identical, so that similar or identical parts are labelled with the same reference signs and reference is also made to the description of the other embodiments or figures in order to avoid repetition.

FIGS. 1 and 2 show an electric energy storage 10 (also known as a battery pack) for a motor vehicle (not shown separately). The energy storage 10 can be arranged in any desired orientation in or on the motor vehicle. The motor vehicle is preferably configured as a lorry. It is also possible that the motor vehicle is configured, for example, as a bus, a construction machine, an agricultural machine or a passenger car.

As a traction battery, the electric energy storage 10 can provide electric energy for at least one electric drive unit for driving the motor vehicle. For example, the motor vehicle can be driven by means of a central electric drive, several electric wheel hub drives or several electric drives close to the wheels. The electric energy storage 10 can, for example, be charged externally via an electric charging cable connected to a charging socket of the motor vehicle.

The energy storage 10 can be attached to a vehicle frame or roof of the motor vehicle. Preferably, the energy storage 10 can be attached to an outer longitudinal side of one of the main longitudinal beams of a vehicle frame designed as a ladder frame of the motor vehicle. Alternatively, the energy storage 10 can, for example, be mounted between the two main longitudinal beams of a vehicle frame designed as a ladder frame of the motor vehicle.

The energy storage 10 comprises a plurality of containers 12, a plurality of battery module groups 14 and a plurality of fastening elements 16.

The containers 12 each comprise a container outer wall 18. The container outer walls 18 are substantially frame-shaped, preferably substantially polygonal frame-shaped, particularly preferably substantially rectangular frame-shaped. Preferably, the container outer walls 18 are completely circumferential or form a closed, multi-sided (e.g. four-sided) frame.

The container outer walls 18 can each comprise two opposing end faces, for example on an upper side and on a lower side of the respective container outer wall 18 or of the respective container 12. The end faces can be circumferential or closed. The end faces can be substantially frame-shaped, preferably substantially polygonal frame-shaped, particularly preferably substantially rectangular frame-shaped.

The container outer walls 18 can each comprise an inner circumferential face and an outer circumferential face. The inner circumferential faces and the outer circumferential faces can be circumferential or closed. The inner circumferential faces can be substantially frame-shaped, preferably substantially polygonal frame-shaped, particularly preferably substantially rectangular frame-shaped. The inner circumferential face and the outer circumferential face can connect the respective opposite end faces of the container outer walls 18.

Each container outer wall 18 may be delimited by the respective two opposing end faces as well as the respective inner circumferential face and the respective outer circumferential face.

The container outer walls 18 can, for example, be cast, preferably from a metal alloy.

The containers 12 are stacked, preferably aligned or flush with each other. Preferably, the containers 12 are stacked by means of the container outer walls 18, particularly preferably at end faces of the container outer walls 18. A stacking direction of the containers 12 is preferably vertical, i.e. the containers 12 are stacked on top of each other. Accordingly, for example, there may be an uppermost container 12 and a lowermost container 12. However, any other stacking direction is also possible, e.g. horizontal, etc.

The containers 12 each accommodate one of the battery module groups 14. The battery module groups 14 may each be arranged or received within the respective container outer wall 18 of the corresponding container 12. The battery module groups 14 may be electrically connected to each other across the containers 12.

The battery module groups 14 each comprise a plurality of battery modules 20. The battery modules 20 each comprise a plurality of battery cells, for example in the form of at least one battery cell stack. A stacking direction of the battery cells can be freely selectable, e.g. vertically or horizontally. The battery cells of a battery cell stack are preferably pressed together. The battery cells of a battery cell stack are preferably connected in series with each other. The battery modules 20 can preferably be connected in parallel. The battery module groups 14 can preferably be connected in parallel.

The battery modules 20 of a battery module group 14 are preferably arranged in a plane, e.g. a horizontal plane. The battery modules 20 of a battery module group 14 are preferably arranged in a row next to each other or in a grid.

A freely selectable number of containers 12 and/or battery modules 20 per battery module group 14 can be adapted to the respective requirements. For example, two, three or four containers 12 can be included. For example, two, three, four, five or six battery modules 20 can be included per battery module group 14. Particularly preferred combinations have been found to be
four containers 12 each comprising one battery module group 14 with three battery modules 20 each, the three battery modules 20 preferably being arranged in a row next to each other (see FIGS. 1 and 2);
three containers 12 each with one battery module group 14 with four battery modules 20 each, wherein the four battery modules 20 are preferably arranged in a grid (not shown separately in the figures); and
two containers 12, each having a battery module group 14 with six battery modules 20, wherein the six battery modules 20 are preferably arranged in a row next to each other or in a grid (not shown separately in the figures).

An electrical connection line 22 can electrically connect the battery modules 20 of a battery module group 14 to one another. The electrical connection line 22 may comprise an electrical connector 24. The electrical connector 24 can be arranged on the container outer wall 18 of the respective container 12. Preferably, the electrical connector 24 can be arranged and held on the outer circumferential face of the respective container outer wall 18, for example in a passage opening to the inner circumferential face of the respective container outer wall 18.

The containers 12 may further each comprise at least one stiffening element 26, a support plate 28, a temperature control device 30, a vent valve 32 and/or a heat insulating element 34.

The at least one stiffening element 26 can be configured, for example, as a stiffening wall or a stiffening strut. The at least one stiffening element 26 can stiffen the respective container 12 or the respective container outer wall 18. The at least one stiffening element 26 can extend between opposite sides of an inner surface of the respective container outer wall 18 or connect them to each other. A respective stiffening element 26 can be arranged between two neighbouring battery modules 20 of a battery module group 14 or spatially separate them from one another. The battery modules 20 and the at least one stiffening element 26 can be arranged alternately.

The support plate 28 can be arranged bottom-side in the respective container 12. The support plate 28 can stiffen the respective container 12. The support plate 28 can support the battery module group 14 of the respective container 12. The support plate 28 can absorb and dissipate operating loads. An upper side of the support plate 28 may be shaped to receive the temperature control device 30. For example, the upper side of the support plate 28 may be shaped for positioning or inserting temperature control coils of the temperature control device 30.

The temperature control device 30 is preferably configured as a temperature control plate, preferably a cooling and/or heating plate. The temperature control device 30 can, for example, be arranged above or below the battery module group 14 of the respective container 12. Preferably, the temperature control device is arranged between the support plate 28 and the battery module group 14. The temperature control device 30 can cool and/or heat the respective battery module group 14 during operation. A temperature control fluid can flow through the temperature control device 30 to effect the heating or cooling. It is possible that a gap filler, for example in the form of a heat-conducting paste, connects the battery modules 20 to the temperature control device 30 in order to bridge a gap between the temperature control device 30 and the battery modules 20.

Connections for supplying and discharging the temperature control fluid can be arranged in the container outer wall 18 of the respective container 12, for example in at least one passage between an inner circumferential face and an outer circumferential face of the respective container outer wall 18. It is possible that the temperature control device 30 is elastically supported or suspended in the respective container 12.

The temperature control devices 30 from the containers 12 may be connected to each other via a common temperature control fluid inflow line 36 and/or a common temperature control fluid outflow line 38. The line 36 and/or 38 may be arranged outside the containers 12. Advantageously, this makes it possible to screw the line 36 and/or 38 from the outside and/or to compensate for manufacturing tolerances and thermal stresses.

The vent valve 32 can vent the respective container 12 by opening when a predetermined pressure is exceeded. Preferably, the vent valve 32 is arranged in a passage between the inner circumferential face and the outer circumferential face of the container outer wall 18 of the respective container 12.

The heat insulating element 34 can be substantially frame-shaped, preferably polygonal frame-shaped, particularly preferably rectangular frame-shaped. The heat insulating element 34 can be arranged on an inner surface of the container outer wall 18 of the respective container 12. The heat insulating element 34 can be arranged between the container outer wall 18 of the respective container 12 and the battery module group 14 arranged in the respective container 12. The heat insulating element 34 can surround the battery module group 14.

The energy storage 10 may comprise a (top) cover 40. The cover 40 may cover the uppermost container 12 from above. The cover 40 may stiffen the uppermost container 12. An upper heat insulating layer 42 of the energy storage 10 may be arranged between the cover 40 and the uppermost container 12. The heat insulating layer 42 may be made of a heat insulating material. The cover 40 and/or the heat insulating layer 42 may be plate-shaped. The cover 40 and/or the heat insulating layer 42 can be polygonal, preferably rectangular. The cover 40 can preferably be fastened to the containers 12 together with the heat insulating layer 42 by means of the fastening elements 16.

The energy storage 10 may comprise a bottom 44. The bottom 44 can cover the lowermost container 12 from below. The bottom 44 may stiffen the lowermost container 12. A bottom heat insulating layer 46 of the energy storage 10 may be arranged between the bottom 44 and the lowermost container 12. The heat insulating layer 46 may be made of a heat insulating material. The bottom 44 and/or the heat insulating layer 46 may be plate-shaped. The bottom 44 and/or the heat insulating layer 46 may be polygonal, preferably rectangular. The bottom 44 may be fastened to the lowermost container 12 by means of a plurality of fastening elements 48 together with the heat insulating layer 46. Alternatively, for example, the fastening elements 16 can fasten the bottom 44 together with the heat insulating layer 46, for example by means of threaded blind holes received in the bottom 44 or securing the bottom 44 to ends of the fastening elements 16 by means of nuts.

The energy storage 10 can comprise at least one frame-shaped sealing element 50. The frame-shaped sealing elements 50 can each rest against the end faces of the container outer walls 18. One sealing element 50 can be arranged between each of two neighbouring containers 12, preferably between opposing end faces of the container outer walls 18 of the two neighbouring containers 12. Similarly, a frame-shaped sealing element 50 can be arranged between the cover 40 or the heat insulating layer 42 and the uppermost container 12. Alternatively or additionally, a frame-shaped sealing element 50 may be arranged between the bottom 44 or the heat insulating layer 46 and the lowermost container 12. The fastening elements 16 may extend through through-holes in the sealing elements 50.

The energy storage 10 can be held together by the fastening elements 16, preferably in a gas-tight manner. The fastening elements 16 each extend through the container outer walls 18 of the plurality of containers 12 and fasten all stacked containers 12 to one another in a force-locking manner. Together with the sealing elements 52, the fastening elements 16 can ensure a sufficient sealing effect for sealing the high-voltage interior from the battery module groups 14 against external environmental influences. The fastening elements 16 can electrically conductively connect all container outer walls 18 to each other in order to enable potential equalisation between the containers 12.

The fastening elements 16 are elongated and preferably rod-shaped. The fastening elements 16 can preferably be configured as screws, bolts or threaded rods.

Specifically, at least the container outer walls 18 of all but one of the outermost (e.g. the lowermost) containers 12 may comprise through-holes through which the fastening elements 16 may extend. The through-holes can be aligned or aligned with each other. The container outer wall 18 of the outermost/lowermost container 12 may comprise either through holes for the fastening elements 16. The fastening elements 16 extending through the through holes can then be secured, for example by means of nuts or the like, which can be positioned below the lowermost container 12, for example at the bottom 44. Alternatively, the fastening elements 16 can, for example, extend through through-holes in the bottom container 12 and be screwed into blind holes in the bottom 44. The through holes of the containers 12 may extend between the opposite end faces of the container outer walls 18. Alternatively, the fastening elements 16 may, for example, extend into blind holes in the container outer wall 18 of the outermost/lowermost container 12 and be screwed into them.

A number of fastening elements 16 can preferably be ≥10, ≥15, ≥20, ≥25, ≥30. The fastening elements 16 can be arranged substantially equidistantly. In each case, several of the fastening elements 16 can extend through each of the substantially straight wall areas of the container outer walls 18. The substantially straight wall regions each extend between the corner regions or corners of the container outer walls 18. The fastening elements 16 can together form a lattice bar cage that protectively surrounds the battery module groups 14.

The length of the fastening elements 16 can depend on the number of containers 12. A length of the fastening elements 16 can, for example, be in a range between 170 mm and 500 mm.

The containers 12 can be centred or positioned relative to one another by means of several centring or positioning elements 52. The centring elements 52 can be configured as studs or pins. The centring elements 52 can be arranged on the end faces of the container outer walls 18. The opposite end wall of the container outer wall 18 of the neighbouring container 12 may comprise corresponding blind holes for receiving the centring elements.

The invention is not limited to the preferred embodiments described above. Rather, a large number of variants and modifications are possible which also make use of the inventive concept and therefore fall within the scope of protection. In particular, the invention also claims protection for the subject matter and the features of the subclaims independently of the claims referred to. In particular, the individual features of independent claim 1 are each disclosed independently of one another. In addition, the features of the sub-claims are also disclosed independently of all the features of independent claim 1 and, for example, independently of the features relating to the presence and/or configuration of the containers, the battery module groups and/or the fastening elements of independent claim 1. All ranges herein are to be understood as disclosed in such a way that, as it were, all values falling within the respective range are disclosed individually, for example also as respective preferred narrower outer limits of the respective range.

### LIST OF REFERENCE SIGNS

10 Energy storage
12 Container
14 Battery module group
16 Fastening element
18 Container outer wall
20 Battery module
22 Electrical connection line
24 Electrical connector
26 Stiffening element
28 Support plate
30 Temperature control device
32 Vent valve
34 Heat insulating element
36 Temperature control fluid inflow line
38 Temperature control fluid outflow line
40 Cover
42 Heat insulating layer
44 Bottom
46 Heat insulating layer
48 Fastening element
50 Sealing element
52 Centring element

1-15. (canceled)

16. An electric energy storage for a motor vehicle comprising:
a plurality of battery module groups, each comprising a plurality of battery modules each comprising a plurality of battery cells;
a plurality of containers that are stacked and each comprise a substantially frame-shaped container outer wall, wherein one of the plurality of battery module groups is arranged in each of the plurality of containers, and
a plurality of fastening elements that are elongated, each extending through the container outer walls of the plurality of containers and fastening the containers to one another.
particularly preferably in a row next to one another or in a grid

17. The electric energy storage according to claim 16, wherein:
the motor vehicle is a utility vehicle; or
the plurality of battery modules per battery module group are arranged in a plane; or
the plurality of battery modules per battery module group are arranged in a plane in a row next to one another or in a grid; or
the container outer walls are each substantially in the shape of a polygonal frame or substantially in the shape of a rectangular frame; or
the container outer walls are each completely encircling.

18. The electric energy storage according to claim 16, wherein:
the plurality of fastening elements are each secured within the electric energy storage; or
the plurality of fastening elements are each secured outside the electric energy storage.

19. The electric energy storage according to claim 18, wherein:
the plurality of fastening elements secured within the electric energy storage are each screwed into a blind hole or a through-hole thread in a bottom of the electric energy storage or of the container outer wall of an outermost container of the plurality of containers; or
the plurality of fastening elements secured outside the electric energy storage each extend through a through-hole in a bottom of the electric energy storage or the container outer wall of an outermost container of the plurality of containers or are each secured with a nut connection.

20. The electric energy storage according to claim 19, wherein the outermost container of the plurality of containers is the outermost lowermost container of the plurality of containers.

21. The electric energy storage according to claim 16, wherein:
the container outer walls each comprise corner wall sections and substantially straight wall sections arranged therebetween, and
a plurality of fastening elements each extend through each of the substantially straight wall sections.

22. The electric energy storage according to claim 16, wherein at least one of the following features is fulfilled:
the plurality of fastening elements are configured as screws, bolts or threaded rods;
a number of the plurality of fastening elements is ≥10, ≥15, ≥20, ≥25 or ≥30, ≥35 or ≥40;
the plurality of fastening elements are arranged substantially equidistantly;
the plurality of fastening elements are arranged in a coordinated manner for applying a fastening force that is uniform around a circumference of the frame-shaped container outer walls; and
the plurality of fastening elements together form a lattice cage that protectively surrounds the battery module groups.

23. The electric energy storage according to claim 16, wherein:
the plurality of fastening elements electrically conductively connect the container outer walls of the plurality of containers to each other for equipotential bonding.

24. The electric energy storage according to claim 16, further comprising:
at least one frame-shaped sealing element arranged between opposite end faces of two adjacent containers of the plurality of containers; or
a plurality of centring elements which align the containers with respect to one another.

25. The electric energy storage according to claim 24, wherein:
the plurality of fastening elements each extend through the at least one frame-shaped sealing element; or
the centring elements are pin-shaped centring elements which align the containers with respect to one another in a flush manner; or
the plurality of centring elements are arranged on end faces of the container outer walls of the containers.

26. The electric energy storage according to claim 16, wherein the plurality of containers each comprise at least one stiffening element which extends between opposing inner sides of the container outer wall of the respective container and is arranged between the plurality of battery modules of the respective battery module group.

27. The electric energy storage according to claim 26, wherein the plurality of containers each comprise a vent valve for venting the respective container when a predetermined pressure is exceeded.

28. The electric energy storage according to claim 27, wherein the plurality of containers each comprise a temperature control device for temperature control of the battery module group arranged in the respective container.

29. The electric energy storage according to claim 27, wherein:
the at least one stiffening element is strut-shaped or wall-shaped; or
the container outer walls each comprise a passage in which the vent valve of the respective container is arranged; or
the plurality of containers each comprise a bottom-side temperature control device which is a cooling and/or heating plate.

30. The electric energy storage according to claim 16, wherein the plurality of containers each comprise a bottom-side support plate which supports the battery module group arranged in the respective container and/or stiffens the respective container.

31. The electric energy storage according to claim 16, wherein the plurality of containers each comprise a heat insulating element which is substantially frame-shaped and arranged between the container outer wall of the respective container and the battery module group arranged in the respective container.

32. The electric energy storage according to claim 16, further comprising:
a cover covering an uppermost one of the plurality of containers from above, and an upper heat insulating layer arranged between the cover and the uppermost container; or
a bottom covering a lowermost one of the plurality containers from below, and a lower heat insulating layer arranged between the bottom and the lowermost container.

33. The electric energy storage according to claim 32, wherein:
the cover is plate-shaped and an upper frame-shaped sealing element is arranged between the uppermost container and the upper heat-insulating layer or the cover; or
the bottom covering is plate-shaped and a lower frame-shaped sealing element is arranged between the lowermost container and the lower heat insulating layer or the bottom.

34. A motor vehicle comprising:
an electric energy storage according to claim 16.

35. The motor vehicle of claim 34 wherein:
the motor vehicle is a commercial vehicle; or
the motor vehicle is a lorry or a bus; or
the electric energy storage is arranged at, on or between a ladder frame of the motor vehicle or on a roof of the motor vehicle.
